(19) United States
(12) Patent Application Publication
(10) Pub. No.: US 2017/0009052 A1
(43) Pub. Date: Jan. 12, 2017

(54) IMPROVED CHEMICAL COMPOUNDS THAT UNDERGO REVERSIBLE CHANGES IN PROPERTIES AND USES THEREOF

(71) Applicant: DYNATINT CORPORATION, L.L.C., Westlake, OH (US)

(72) Inventor: Andrew A. Sokol, N. Olmstead, OH (US)

(73) Assignee: DYNATINT CORPORATION, L.L.C., Westlake, OH (US)

(21) Appl. No.: 15/115,800

(22) PCT Filed: Jan. 30, 2015
(86) PCT No.: PCT/US2015/013936

§ 371 Date: Aug. 1, 2016

Related U.S. Application Data
(60) Provisional application No. 61/933,377, filed on Jan. 30, 2014.

(51) Int. Cl. C08K 5/08; C09D 11/50; C09K 9/02; B05D 1/30; C09B 13/00; C08K 5/357; C08J 5/18; C09D 125/06; C09K 15/08; C09B 67/22

(52) U.S. Cl. CPC C08K 5/08; C09K 15/08; C09D 11/50; C09K 9/02; C09B 67/0033; C09B 13/00; C08K 5/357; C08J 5/18; C09D 125/06; B05D 1/30; C09K 2211/1029; C09K 2211/1011; C08J 2325/06

(57) ABSTRACT

Free radical scavengers, especially those that require the presence of oxygen, are useful in extending the life of photochromic, thermochromic, electrochromic, radiochromic, magnetochromic, photo-electrochromic and similar dyes. Particularly, preferred scavengers are the quinones be it O, M or p- and, most preferably, either the ortho, meta or para-hydroquinone. The so-enhanced dye can be used as a coating or cast as a film.

### CROSS-REFERENCE TO RELATED APPLICATIONS

This application is a completion application of U.S. Provisional Patent Application Ser. No. 61/933,377, filed Jan. 30, 2014 for “Improved Chemical Compounds That Undergo Reversible Changes in Properties and Uses Thereof”, the entire disclosure of which is hereby incorporated by reference.

### BACKGROUND OF THE INVENTION

1. Field of the Invention

The present invention concerns photochromic, thermochromic, electrochromic, radiochromic, magnetochromic, photo-electrochromic and similar chemical compounds which undergo reversible changes in properties such as physical structure and color change in reaction to exposure to external energy sources such as, but not limited to, ultraviolet light, infrared and/or electricity. More particularly, the present invention concerns means and methods for extending the useful life of such compounds, thus enhancing them with increased commercial value and wider ranging uses.

2. Prior Art

Photochromic, thermochromic and other such compounds are well-known and commercially available for purchase. However these materials share one drawback in that their useful life is a few weeks or months, at most. Immediately upon first activation and return to ground state, these chemicals begin to exhibit increasingly slower and slower reaction times, ultimately failing to react to the activation energy.

Photochromic, thermochromic and other such compounds or chemicals are available as dyes, including encapsulated dyes and the like. These dyes are chemicals that change physical properties in reaction to certain environmental conditions to which they are exposed. These conditions can be, but are not limited to, heat, visible light, UV light, x-rays, electricity, static electricity and other electromagnetic energy. When this activation energy is absorbed by the molecules they are deemed in an “energized state”, “excited state”, “activated” or “activated state”. The molecules react to the activation energy by undergoing reversible change(s) such as physical structure and/or color. Removal of the activation energy source results in the molecules returning to their original “ground state” and their original physical and chemical properties.

In the case of thermochromic dyes, they change physical structure and color in reaction to changes in temperature or infrared (IR) exposure.

Photochromic dyes change in response to certain characteristic frequencies in the ultraviolet (UV) and/or visible (Vis) light spectrum. The activation energy frequencies in the electromagnetic spectrum that these dyes respond to are integral, particular and specific characteristics of each particular chemical, dye or blend thereof.

Photochromic materials such as triarylmethanes; stilbenes; azastilbenes; nitrones; fulgides; spiropyrans; naphthopyrans; spiroxazines; quinones; and the like have two states: ground and excited, and their interconversion can be controlled through the manipulation of their electromagnetic activation energy. Excitation with any given wavelength energy will result in a mixture of the two states at a particular ratio, called the “photostationary state”. In an ideal system, there would exist wavelengths that can be used to provide a 1:0 and 0:1 ratio of the isomers, but in actual systems this is not possible, since the activation energy absorbance bands overlap to some extent. The two states of the molecule should be thermally stable under ambient conditions for a reasonable time. For example, nitrospiropyran which back-isomerizes in the dark over about 10 minutes at room temperature is considered photochromic.

All photochromic molecules back-isomerize from their energized state to their more stable ground state at some rate. This holds true for moieties with activation energies outside of the UV/Vis range.

In cases that heat energy (IR) is not responsible for the transformation, back-isomerization can be accelerated by heating. There is, therefore, a close relationship between photochromic and thermochromic compounds. The timescale of thermal back-isomerization, or reversion to ground state, is important for commercial applications, and may be engineered or manipulated.

Photochromic compounds considered to be “thermally stable” include some diarylethenes, which do not back isomerize even after heating at 80° C. for three months.

Other chemicals that undergo reversible, characteristic change such as physical structure, color change and other properties in reaction to their environmental conditions do so by similar mechanisms. These chemical systems are similarly affected by factors detrimental to their practical and effective, useful service life.

Perhaps the best and most widely known use of photochromic dyes are as eyeglass lenses. These lenses, on exposure to sunlight, react to the ultraviolet (UV) light in the sunlight and darken to become sunglasses. These lenses then return to their ground state, colorless form, when they are removed from the sunlight (UV).

However, these prior art lenses are limited by an effective dye life of approximately 24 months.

Furthermore, in order to incorporate photochromics into working systems, they suffer the same issues as other dyes. They are often charged in one or more states, leading to very high polarity and possible large changes in polarity. They also often contain large conjugated systems that limit their solubility.

Although not wishing to be bound by any theory, it has been postulated that photochromic dyes, and other such moieties that change with exposure to external energy, are damaged by naturally occurring free radicals created by UV light and other means such as natural kinetics. To overcome this problem UV blockers are incorporated into the dye formulation to mitigate such damage from detrimental moieties. Ordinarily, the UV blockers used are from two classes/types:
(a) Ultraviolet Light Absorbers (UVA's), and;
(b) Hindered Amine Light Stabilizers (HALS)

Hindered Amine Light Stabilizers (HALS) and UVAs are well known and commercially available such as those marketed by BASF under the trade name Tinuvin®.

However, the use of these UV blockers, absorbers and stabilizers, while providing some increase in the service life of the dyes, inevitably results in the loss of photochromacity. Further, UV blockers, absorbers and stabilizers necessitate higher concentrations of photochromic dye to achieve the same chromophoric density than without the use of these UV interventive compounds.

Additionally, the UV blockers and/or absorbers used to increase photochromic dye life ultimately compete for the same UV light energy that the dyes require to achieve their energized state. This effectively limits application uses behind plastic, glass or windows that usually block or attenuate the UV light needed to energize the dyes

As a result, photochromic products do not work, or work very poorly, when used behind window glass such as within a vehicle. While the useful life of photochromic compositions is slightly increased with UV blockers, they limit commercial applications such as window tints for glass and do not provide a viable, cost-effective means to significantly increase the useful life of the dyes.

Thermochromics sustain damage not only from free radicals but from singlet oxygen. Singlet oxygen, the common name used for an electronically excited state of molecular oxygen (O₂), is less stable than normal triplet oxygen. Because of its unusual properties, singlet oxygen can persist for over an hour at room temperature, depending on the environment.

Singlet oxygen is usually generated with a photosensitizer pigment. The damaging effects of sunlight on many organic materials (polymers, etc.) are often attributed to the effects of singlet oxygen.

Singlet oxygen comes from several sources such as ambient air, water/moisture, chemicals, and as a by-product from chemical reactions. Thus photochromic molecules can be damaged by moisture which can stem from ambient humidity or incidental exposure to water.

The present invention, as subsequently detailed, seeks to overcome the useful service life deficiency in these dyes.

### SUMMARY OF THE INVENTION

It has been found that free radical scavengers, especially those that require the presence of oxygen, are useful in extending the life of photochromic, thermochromic, electrochromic, radiochromic, magnetochromic, photo-electrochromic and similar dyes. Particularly, free radical scavenging quinones have been found to be particularly effective because they not only scavenge free radicals, they, also, require the presence of oxygen to accomplish this. These moieties thus perform two functions that protect the dyes, to wit:
(a) scavenge free radicals, and;
(b) scavenge singlet oxygen, oxygen and —OH groups that are suspected of damaging the dyes.

The quinones that can be used herein correspond to the formula:

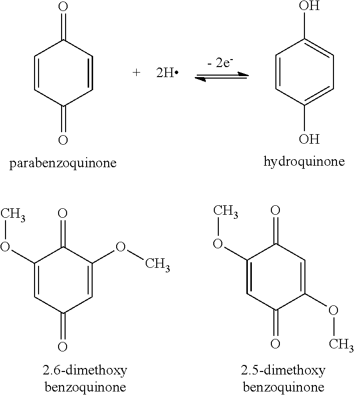

The quinone may be used either as a liquid or as a powder and is admixed with the dye at ambient conditions

For a more complete understanding of the present invention reference is made to the following detailed description and accompanying example.

### DESCRIPTION OF INVENTION

At the outset, it should be noted that as used herein, terms such as “thermochromic”, “photochromic”, “electrochromic”, “radiochromic”, “magnetochromic” “photo-electrochromic” and the like may be used interchangeably and refers to chemicals and, in particular, dyes which change physical properties in reaction to the environmental conditions to which they are exposed.

As noted above, the prior art teaches incorporation of UV blockers and absorbers increases photochromic dye life to extend the useful service life of the dyes up to a few months. By incorporating free radical scavenger(s), alone, or with other protective moieties, the useful service life of photochromic dyes, and other such chemical species as described above, can be significantly extended over the teachings of the prior art.

Further, and as noted above, the present invention is based on the discovery that that free radical scavengers, especially those that require the presence of oxygen, are useful in extending the life of photochromic, thermochromic, electrochromic, radiochromic, magnetochromic, photo-electrochromic and similar dyes. Particularly, free radical scavenging quinones have been found to be particularly effective because they not only scavenge free radicals, they, also, require the presence of oxygen to accomplish this. These moieties thus perform two functions that protect the dyes, to wit:
(c) scavenge free radicals, and;
(d) scavenge singlet oxygen, oxygen and —OH groups that are suspected of damaging the dyes.

The quinones that can be used herein correspond to the formula:

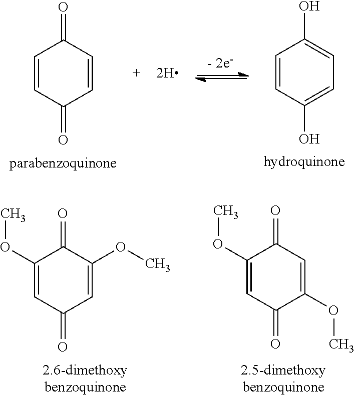

The quinone may be used either as a liquid or as a powder and is admixed with the dye at ambient conditions.

Among the useful quinones, the preferred quinone is a hydroquinone be it the ortho-, meta- or para-isomer. Each isomer exhibits utility in the practice of the present invention.

The quinones of the present invention may be used in connection with the following compounds which undergo dynamic reversible changes in structure and/or other properties, including, for example:

(a) triarylmethanes; (b) stilbenes; (c) bisimidazols; (d) spirodihydroindolizines; (e) azastilbenes; (f) nitrones; (g) benzos; (h) fulgides; (i) fulgimides; (j) spiropyrans, such as thiospyropyrans; (k) spiroxazines; (l) naphthopyrans; (m) quinones, such as phenoxynaphthacene quinone; (n) quinines; (o) indenopyrans; (p) perimidinespirocyclohexadienones; (q) viologens; (r) ideno-fused napthopyrans; (s) inorganic metal halides, such as, for example, silver chloride, zinc halides and the like; (t) coordination compounds such as, for example, sodium nitroprusside, ruthenium sulfoxide compounds, including ruthenium polypyridine; (u) diarylethenes; (v) hydrazines; (w) anils; (x) aryl thiosulfonates; (y) spiroperimindines and the like.

For example, among the dyes which may be used in conjunction with the free radical scavenger(s) hereof, are: benzyl viologen dichloride with molecular formula of (C₂₀H₂₂C₁₂N₂) and molecular structure of:

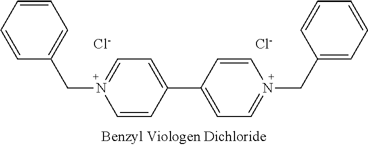

1,3-dihydro-1,3,3-trimethylspiro[2H-indole-2,3′-[3H]naphth[2,1-b][1,4]oxazine] with molecular formula of (C₂₂H₂₀N2O) and molecular structure of:

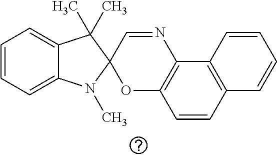 [SMILES: CN1c2ccccc2C(C)(C)C12C=Nc1c(ccc3ccccc13)O2]

1′,3′-dihydro-1′,3′,3′-trimethyl-6-nitrospiro[2H-1-benzopyran-2,2′-(2H)-indole] with molecular formula of (C₁₈H₁₈N₂O₃) and molecular structure of:

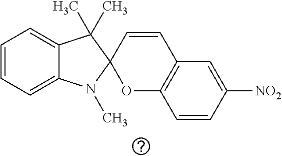 [SMILES: CN1c2ccccc2C(C)(C)C12C=Cc1cc([N+](=O)[O-])ccc1O2]

1,1′-diheptyl-4,4′-bipyridinium dibromide with molecular formula of (C₂₆H₃₈Br₂N₂O₂) and molecular structure of:

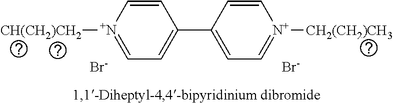

1,3-dihydro-1,3,3-trimethylspiro[2H-indole-2,3′-[3H]naphth[2,1-b][1,4]oxazine] with molecular formula of (C₂₁H₃₈Br₂NO₂) and molecular structure of:

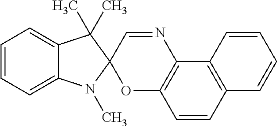 [SMILES: CN1c2ccccc2C(C)(C)C12C=Nc1c(ccc3ccccc13)O2]

4,4′-dipyridyl with molecular formula of (C₁₀H₁₈N₂) and molecular structure of:

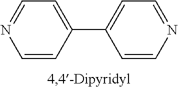 [SMILES: c1cc(-c2ccncc2)ccn1]

Indoine blue dye with molecular formula of (C₂₉H₂₄ClN₅O) and molecular structure of:

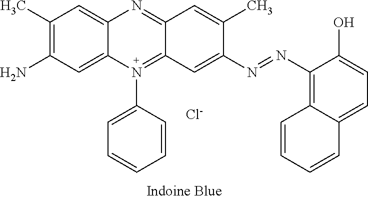

Methyl viologen dichloride hydrate with molecular formula of (C₁₂H₁₄C₁₂N₂.xH₂O) and molecular structure of:

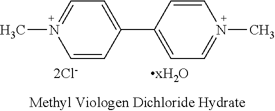

2,3,3-trimethyl-1-propyl-3H-indolium iodide with molecular formula of (C₁₄H₂₀IN) and molecular structure of:

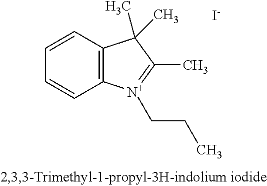

The present invention may also be used with leuco dye(s). A leuco dye is a thermochrome coloring agent or ink which can acquire two different forms: a colorless form and a colored form. At warm temperatures, the thermochromic ink is colorless. At cold temperatures, the thermochromic ink takes on a different color, e.g., blue. The thermodynamically reversible interconversion is pushed to the blue form of the excited state when the ink cools below the color changing temperature.

Again, although not wishing to be bound by any theory, it is believed that the following mechanism is how the subject chemicals develop coloring: Typically, a molecule will absorb one wavelength of light better than other wavelengths, and this wavelength of maximum absorption is designated “λₘₐₓ”. For example, lycopene is red because its λₘₐₓ is in the blue region. It absorbs light in the blue region and reflects light in the red region and thus appears red. If the extended conjugated π-electron system in the middle of the π-bond system is disrupted, the extended π-system would be severely shortened, and the molecule would, shift color or become colorless. For this reason the most widely used thermochromic inks contain an extended conjugated π-system that is easily interrupted.

This is represented as follows:

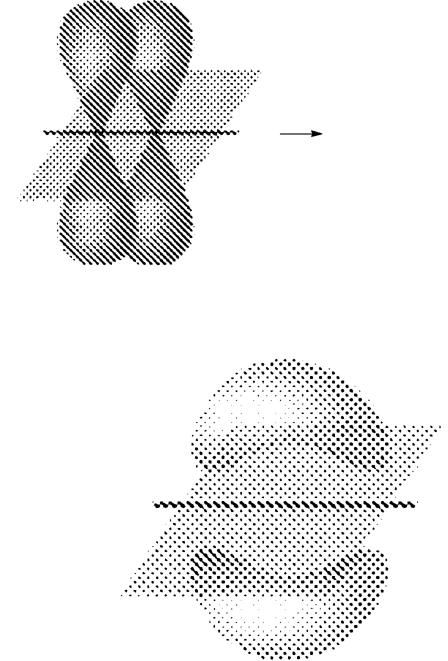

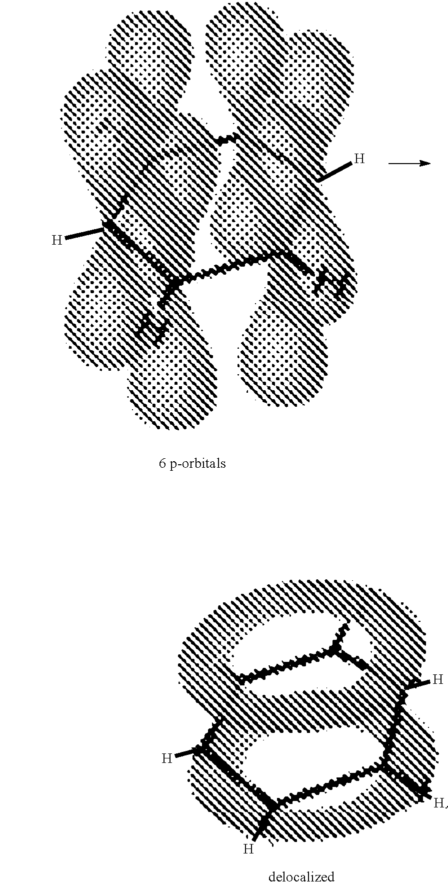

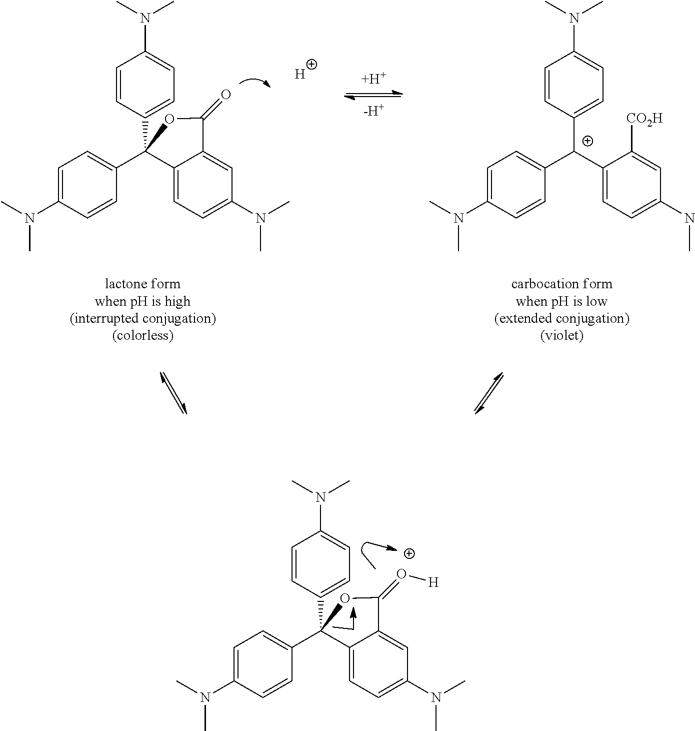

The present invention is also applicable to spiropyrans and spiroxazines. One of the oldest and, perhaps, the most studied families of photochromes are the spiropyrans. Very closely related to these are the spiroxazines. For example, the spiro form of an oxazine is a colorless leuco dye; the conjugated system of the oxazine and another aromatic part of the molecule is separated by a sp3-hybridized “spiro” carbon. After exposure to UV light, the bond between the spiro-carbon and the oxazine breaks, the ring opens, the spiro-carbon achieves sp2 hybridization, becomes planar, the aromatic group rotates, aligns its π-orbitals with the rest of the molecule, and a conjugated system forms with ability to absorb wavelengths of visible light, and therefore appears colorful. When the UV source is removed, the molecules gradually return to their ground state, the carbon-oxygen bond reforms, the spiro-carbon becomes sp3 hybridized again, and the molecule returns to its colorless state.

This class of photochromes, in particular, are thermodynamically unstable in one form and revert to the stable form in the dark unless cooled to low temperatures. Their lifetime can also be affected by exposure to UV light. Like most organic dyes they are susceptible to degradation by oxygen and free radicals. Incorporation of the dyes into a polymer matrix or providing a barrier to oxygen and chemicals by other means prolongs their lifetime.

Still another class of useful dyes which are enhanced by the present invention are the diarylethenes. The “diarylethenes”, such as dithienylethenes, have gained widespread interest, largely on account of their high thermodynamic stability. They operate by means of a 6-π electrocyclic reaction, the thermal analog of which is impossible due to steric hindrance.

Pure photochromic dyes usually have the appearance of a crystalline powder, and in order to achieve the color change, they usually have to be dissolved in a solvent or dispersed in a suitable matrix. However, some diarylethenes have so little shape change upon isomerization that they can be converted while remaining in crystalline form.

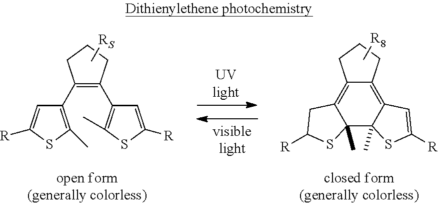

Azobenzenes may also be used in the practice hereof. The trans-cis isomerization of azobenzenes has been used extensively in molecular switches, often taking advantage of its shape change upon isomerization to produce a supramolecular result. In particular, azobenzenes incorporated into crown ethers give switchable receptors and azobenzenes in monolayers can provide light-controlled changes in surface properties.

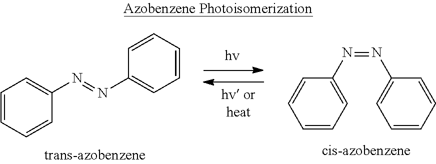 [SMILES: c1ccc(/N=N/c2ccccc2)cc1 ; c1ccc(/N=N\c2ccccc2)cc1]

The forces responsible for the spatial organization may vary from weak (intermolecular forces, electrostatic or hydrogen bonding) to strong (covalent bonding), provided that the degree of electronic coupling between the molecular component remains small with respect to relevant energy parameters of the component. While traditional chemistry focuses on the covalent bond, supramolecular chemistry examines the weaker and reversible, non-covalent interactions between molecules. These forces include hydrogen bonding, metal coordination, hydrophobic forces, van der Waals forces, π-ππ interactions and electrostatic effects. Important concepts that have been demonstrated by supramolecular chemistry include molecular self-assembly, folding, molecular recognition, host-guest chemistry, mechanically-interlocked molecular architectures, and dynamic covalent chemistry.

As noted above, quinones are capable of being enhanced by the practice of the present invention. Some quinones, and phenoxynaphthacene quinone in particular, have photochromacity resulting from the ability of the phenyl group to migrate from one oxygen atom to another. Quinones with good thermal stability also have the additional feature of redox activity, leading to the construction of many-state molecular switches that operate by a mixture of photonic and electronic stimuli.

The scavengers, and in particular the quinones hereof, can be used alone or in combination with other adjuvants, such as desiccants, oxygen scavengers, and the like including, for example: hydrazine; ascorbic acid; tocopherol; naringenin; n-aminomorpholine; 1-amino-4-methylpiperazinen-aminohexamethylleneimine; 1-aminopyrrolodine; 1-aminopiperidine and the like as well as mixtures thereof. Similarly, mixtures of quinones may be used.

In cases of highly complex mixtures of chemical species that are detrimental to the dyes, equally complex mixtures of scavengers/stabilizers, desiccants and other adjuvants may be needed to overcome those detrimental species that limit the dye service life.

Generally, the quinone is used in amounts ranging from about 0.0001 percent to about 200 percent or greater of the total weight of the dye itself; and preferably from about 0.0025 percent to about 100 percent, by weight, based on the total weight of the dye. The concentration, complexion and complexity of scavengers/stabilizers, desiccants and such other adjuvants is dependent upon the type of aggression in processing the dyes, i.e., solvent drawdown versus thermal extrusion. This is due to the fact that different processing methods present conditions that damage certain stabilizers and compensations must me made to overcome components that are rendered inert from processing.

Where used with other adjuvants, the scavengers are present in a weight ratio of scavenger to adjuvant of from about 1:10 to about 10:1.

The improved dyes hereof can be deployed as either a liquid, pellets or as a powder for use as a coating or cast as a film. Typically, however, a dye formulation is prepared by admixing the dye, per se, with the scavenger(s), at room temperature.

In use, the dye(s) are solubilized in a suitable organic solvent such as, for example, toluene, methyl ethyl ketone, ethyl acetate, hexane, heptane, xylenes, tetrahydrofuran, acetone or the like with stirring until a homogeneous liquid mixture or liquid composition is obtained. It should be noted that dependent upon the selected dye and its solubility it may be necessary to solubilize the scavenger and any adjuvants in a second solvent batch and then mix the two together. Regardless of which way the dye and scavenger mixture is obtained, i.e., a single or double batch, the resulting mixture can then be cast as a film or incorporated into a coating composition or the like.

Ordinarily, the solvent will comprise about 1 percent to about 75 by weight, of the liquid composition, and preferably from about 5 percent to about 50 percent, by weight of the total liquid composition.

The dye composition may be admixed, at room temperature, with a polymer resin. When used with a polymer resin, the amount of the dye composition, i.e., dye, scavenger(s), solvent and resin, will vary depending on the desired density of the dye, i.e., the degree of desired darkness as well as the thickness of any film or extrusion which incorporates the dye composition.

Although many polymer resins may be used, among those useful polymer resins is, for example, polystyrene, polycarbonate, polypropylene, polyurethane, polyuria, polyethylene and the like. Mixtures of resins may be used.

Preferred resins are polystyrene and polycarbonate.

Ordinarily, the polymer resin will comprise from about one percent to about sixty-five percent, by weight, of the entire dye composition and usually from about five percent to about fifty percent, by weight, of the dye composition.

The improved photochromic, thermochromic and electrochromic dye compositions hereof have many commercial uses, including, as noted above, sunglasses, glass/window tint such as automotive grade window tinting films, and other films, coatings, extrusions, co-extrusions, blow molding slugs as well as specified performance grades of materials, e.g., military, optical, automotive, medical, etc.; for bottles and other plastic packaging and containers; as well as in printing and textile inks; paints and other coatings; bulk plastics, such as plastic toys and other structural, laminating and decorative plastics. These improved dye systems can be cast as thin films for use as window tints, as well. When cast as a film, the plastic resin may be directly admixed or coated with the dye(s), scavenger(s) and solvent(s).

As is known, molecular switches can be used to impart functionality, e.g., turning on and off molecules, such as activating enzymes (and other molecular species) and deactivating them on command. The present invention may be used to increase the switch life of molecular switches, which ordinarily exhibit a short useful service life, to make them commercially viable.

Other uses for the extended life photochromic dyes hereof include, for example, in positionally-controlled diamond mechanosynthesis and in conjunction with diamondoid medical nanorobots. Other uses include for example, nanofactory, suparmolecular chemistry, data storage, molecular robotics, biochips, DNA machines and the like.

For a more complete understanding of the present invention, reference is made to the following illustrative example. In the example all parts are by weight absent indications to the contrary.

### Example

This example illustrates the preparation of a cast film in accordance with the present invention: At room temperature and into a suitable container is added 7.0 parts of polystyrene along with 6.0 parts of xylene. Contemporaneously, 0.04 parts of parabenzophenone and 0.06 parts of 1,3-dihydro-1,3,3-trimethylspiro[2H-indole-2,3′-[3H]naphth[2,1-b][1,4]oxazine] is added thereto. The mixture is stirred until a homogeneous liquid is obtained. Thereafter the mixture is cast on to a glass substrate and drawn to a thin film and let to stand until the solvent evaporates. The so-obtained film easily separates from the glass and may then be used as desired.

From the above it is to be readily appreciated that the present invention provides both means and methods for extending the useful service life of the reversible property dyes described herein.

1. An extended useful life reversible dye comprising:
(a) a dye selected from the group consisting of: photochromic, thermochromic, electrochromic, radiochromic, magnetochromic and photo-electrochromic dyes; and
(b) an effective amount of a free radical scavenger.

2. The dye of claim 1 wherein the free radical scavenger is a quinone.

3. The dye of claim 2 wherein the quinone is selected from the group consisting of:

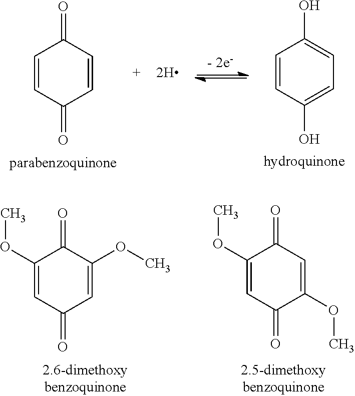

4. The dye of claim 3 wherein, the quinone is hydroquinone.

5. The dye of claim 1 wherein the free radical scavenger is a quinone selected from the group consisting of:

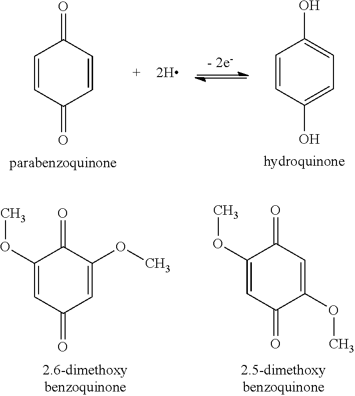

6. The dye of claim 1 wherein the scavenger is a hydroquinone.

7. The dye of claim 1 wherein, the quinone is present in an amount ranging from about 0.001 percent to about 200 percent based on the total weight of the mixture of dye and quinone.

8. The dye of claim 1 further comprising:
(a) a solvent, the solvent being present in an amount ranging from about five percent to about fifty percent, by weight, based on the total weight of the composition.

9. A cast film comprising:
the extended useful life dye of claim 1.

10. The dye of claim 1 wherein, the dye is an ink.

11. A method for extending the useful life of a reversible dye, comprising:
admixing with a reversible dye an effective amount of a free radical scavenger.

12. The method of claim 11 wherein, the free radical scavenger is a quinone.

13. The method of claim 12 wherein, the quinone is selected from the group consisting of:

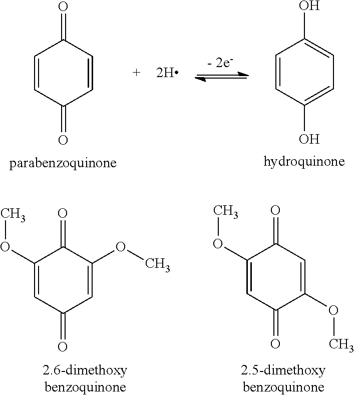

14. The method of claim 13 wherein, the dye is selected from the group consisting of:
photochromic, thermochromic, electrochromic, radiochromic, magnetochromic, and photo-electrochromic.

15. The method of claim 14 which further comprises:
admixing the dye and quinone with a solvent and a polymer resin.

16. The method of claim 15 wherein the resin is polystyrene.

17. The method of claim 16 which further comprises:
casting the admixture into a surface to form a film thereon.
